(19) United States
(12) Patent Application Publication
(10) Pub. No.: US 2015/0287548 A1
(43) Pub. Date: Oct. 8, 2015

(54) Self-limiting electrolyte filling method

(71) Applicant: Thomas Hecht, Dresden (DE)

(72) Inventor: Thomas Hecht, Dresden (DE)

(73) Assignee: Evonik Litarion GmbH, Kamenz (DE)

(21) Appl. No.: 14/411,307

(22) PCT Filed: Jun. 21, 2013
(86) PCT No.: PCT/EP2013/062971

§ 371 Date: Dec. 24, 2014

(30) Foreign Application Priority Data
Jun. 28, 2012 (DE) 10 2012 211 153.0

(51) Int. Cl. H01G 11/84; H01M 2/36; H01M 2/14; H01G 11/22; H01M 4/139; H01G 11/58; H01G 11/52; H01M 10/0525; H01M 4/13

(52) U.S. Cl. CPC H01G 11/84; H01M 10/0525; H01M 2/362; H01M 2/14; H01M 4/13; H01M 2/145; H01M 4/139; H01G 11/58; H01G 11/52; H01G 11/22; H01M 2220/20

(57) ABSTRACT

The invention relates to a method for producing an electrochemical cell, in particular a secondary battery or a double-layer capacitor, in which a cell vessel containing at least one porous cell component is filled with a flowable electrolyte. It is based on the object of providing a method involving simpler equipment that reacts to the fluctuating free volume with an adapted filling amount of electrolyte in the interests of optimum filling.

This object is achieved by providing that, in a first filling step, an excess amount of electrolyte is introduced, in which the porous cell component is completely immersed, that the electrolyte introduced is subjected to a force that drives out of the cell vessel the part of the electrolyte that is not located in the pores of the porous component and that, in a second filling step, an added amount of electrolyte is introduced.

The present invention relates to a method for producing an electrochemical cell, in particular a secondary battery or a double-layer capacitor, in which a cell vessel containing at least one porous cell component is filled with a flowable electrolyte. Such a method is known inter alia from U.S. Pat. No. 6,387,561 B1.

The invention also relates to an installation for producing electrochemical cells and to the use of this installation for carrying out the method according to the invention.

For the purposes of the invention, an electrochemical cell is a store for storing or converting electrical energy by using electrochemical effects. Electrochemical effects may be understood as meaning for example rearrangement phenomena of ions, such as take place for example in secondary batteries (rechargeable batteries) or double-layer capacitors (Supercaps) or electrolytic capacitors (Elcaps). Similarly, electrochemical effects may be understood as meaning electrochemical reactions, such as take place in the conversion of electrical energy into chemical energy or vice versa in fuel cells. It is unimportant for the implementation of this invention on the basis of which effects the energy is stored or converted in the electrochemical cell. What is decisive is that the electrochemical cell has at least one porous cell component. Generally, every electrochemical cell has at least three porous cell components, specifically two electrodes (anode, cathode) for producing the polarity and at least one separator for separating the electrodes. In the case of a ready-to-use electrochemical cell, these elements are surrounded by an electrolyte, which is usually liquid. The electrodes, the separator and the electrolyte are contained in the cell vessel.

Whenever an electrode is mentioned in relation to this invention, the polarity of this electrode does not matter. For the purposes of the invention, the anode and the cathode are equally electrodes. In the technical configuration of electrochemical cells, the electrodes are often configured in a multipart form, that is to say that a multiplicity of cell components are brought together to form an electrode that is a unified entity in electrochemical terms.

The number of separators to be fitted is dependent on the arrangement of the electrodes in the cell vessel. At least one separator, which separates the two electrodes from one another, should be provided. If the electrodes are stacked or wound one inside the other, it may be necessary to arrange a plurality of separators between the electrodes. The separator is the electrochemically inactive component that separates the electrodes from one another in an electrically insulating manner, but is permeable to the ions that are free to move in the electrolyte. For this reason, the separator is highly porous, in order to allow a high degree of ion permeability, and consequently a high level of performance of the cell.

Not only the separator of an electrochemical cell is porous, but also the electrodes. This is attributable to the fact that, in the interests of a high power density, a particularly large electrode surface is required, since the electrochemical reactions or rearrangements take place on the surface of the active materials. In order to achieve a high surface area in spite of a small overall size of the electrode, the active material becomes porous, which means it is applied with a large inner surface area to the current collector of the electrode. The large inner surface area of the active material ultimately leads to a porosity of the electrode as a whole.

Whenever a porous cell component is mentioned here, this should be understood in particular as meaning a collective term for the electrodes or the separator.

It is unimportant for the invention whether the electrodes are laid flat one on top of the other in a stacked manner or are wound. Both types of cell construction are known in the prior art. The type of construction is not relevant for the invention.

What is decisive, however, is that at least one of the cell components is to a certain extent porous and that the porosity fluctuates in the production process. In practice, both electrodes and the separator are porous and are subject to production-related fluctuations.

Porosity should be understood as meaning that the volume calculated from the geometrical external dimensions of the components (exterior volume) does not coincide with the actual space enclosed by material. Rather, the solids in the electrodes or in the separator enclose void regions in the form of pores, which are referred to hereinafter as the “free volume”. The free volume within the cell is to be filled with electrolyte, in order to allow unhindered exchange of the ions over the entire surface area of the electrodes. All the pores of the separator are also to be filled, in order to allow unhindered passage of the ions through the separator.

In order to achieve an optimum function and a high level of performance of the cell, the free volume within the cell must be filled with electrolyte as completely as possible. On the other hand, an excessive surplus of electrolyte must be avoided for reasons of safety. Since the porosity of the components, and consequently the free volume within the cell, fluctuate for production-related reasons, this means that the amount of electrolyte with which the cell is optimally to be filled fluctuates.

According to the prior art of battery production, fluctuations of the free volume are scarcely taken into account. Rather, the known prior art in the area of electrolyte filling methods pursues the maintenance of a fixed amount of electrolyte in every cell, irrespective of how large the actual free volume turns out to be.

For instance, U.S. Pat. No. 8,047,241 B2 describes a filling process in which a particularly high vacuum is to be created in the electrochemical cell. However, the filled amount of electrolyte is prescribed (step d in U.S. 8,047,241 B2).

U.S. 2011/0171503A1 also describes the filling of a predefined amount of electrolyte into an electrochemical cell.

U.S. Pat. No. 6,387,561 B1 is concerned with a filling method for a wound cell, in which the electrolyte is introduced through a core of the winding of a hollow configuration, until the electrodes are immersed in the electrolyte. For this reason, this invention is based on U.S. Pat. No. 6,387,561 B1 as the closest prior art. However, the amount of electrolyte introduced here is constant.

It is known from JP05190168 to fill the cell vessel with a prescribed amount of electrolyte and to subject the cell vessel to vibration, in order in this way to drive out excess gas from the cell vessel.

In DE2729034A1, primary batteries are filled with electrolyte by the cell vessels—here button cells—being introduced into a vacuum chamber and, by evacuating the chamber, being subjected to an external force, which sucks the electrolyte into the cell vessel. No allowance is made here for fluctuating porosities.

It is known from JP2011-134631A to evacuate a cell in a film bag during the filling and to carry out the expansion of the cell vessel during the filling with the electrolyte in a controlled manner by acting on the cell bag by means of plane-parallel plates lying against its outer side. Here, too, the cell is filled with a prescribed amount of electrolyte.

This prior art shares the common feature that the cells are in each case filled with a prescribed amount of electrolyte, irrespective of how great the actual free volume within the cell turns out to be. This inevitably has the effect that, with fluctuating porosity, the filling level in the cell fluctuates. With comparatively rigid cell vessels (such as button cells DE2729034A1), this scarcely presents any technical problems. However, fluctuating amounts of electrolyte have an effect on the mechanical behaviour of electrochemical cells in which the cell vessel is formed by a thin, flexible skin. For instance, high-performance or high-energy-containing lithium-ion secondary batteries are nowadays happily configured as so-called “pouch cells”. These are battery cells in which the cell vessel is produced from aluminium foil and/or plastic film. Thin-skinned pouch cells react to fluctuating amounts of electrolyte with changes in the overall space requirements, which are a hindrance in the highly concentrated assembly of battery modules. However, a greater problem is that the vibration-dynamic natural frequency is changed significantly by differing filling amounts of electrolyte, since the damping provided by the electrolyte varies. When such electrochemical cells are used in mobile applications, such as in particular in vehicles driven by lithium-ion batteries, the changed vibrational behaviour in running operation leads to an unpredictable ageing of the electrical and mechanical connecting elements between the cell and further components of the battery. Mention should be made here in particular of the sealing seams of the cells, which are clamped into the battery frame. This connection undergoes loading caused by cell vibrations, and in the worst case even comes undone. Furthermore, the connection between the cell, the arrester and the cell connector is impaired by these vibrations.

Apart from the influences of the amount of electrolyte on the mechanical properties of the cell, there is an important relationship between the amount of electrolyte and the performance of the cell. An insufficient amount of electrolyte leads to early cell ageing, an excessive amount of electrolyte can present a potential safety risk.

For this reason, there is a need to adapt the amount of electrolyte in an electrochemical cell as exactly as possible to the free volume that is actually present.

This object is already achieved by an invention that is set out in the previously published German patent application DE102012208222A1. In the case of this method, a variable amount of electrolyte is introduced into the cell vessel in order to compensate for fluctuations of the free volume. The optimum filling amount is achieved however by taking a control engineering approach, in which the free volume is predicted by means of statistical methods and the amount of electrolyte to be introduced is adapted to it. An advantage of this method is a low filling error even when there are relatively strong fluctuations in porosity. A disadvantage of this method is greater complexity of the equipment involved, owing to the required control engineering.

With a view to this solution, the invention is based on the object of providing a method involving simpler equipment that reacts to the fluctuating free volume with an adapted filling amount of electrolyte in the interests of optimum filling.

This object is achieved by providing that, in a first filling step, an excess amount of electrolyte is introduced, in which the porous cell component is completely immersed, that the electrolyte introduced is subjected to at least one force that drives out of the cell vessel the part of the electrolyte that is not located in the pores of the porous component and that, in a second filling step, an added amount of electrolyte is introduced.

The subject matter of the invention is consequently a method for producing an electrochemical cell, in particular a secondary battery or a double-layer capacitor, in which a cell vessel containing at least one porous cell component is filled with a flowable electrolyte, and which has the following steps:
a) in a first filling step, an excess amount of electrolyte is introduced, in which the porous cell component is completely immersed,
b) then, the electrolyte introduced is exposed to at least one force that drives out of the cell vessel the part of the electrolyte that is not located in the pores of the porous component,
c) after that, in a second filling step, an added amount of electrolyte is introduced.

The present invention is based on the finding that electrolyte that is located outside the pores of the porous cell components can be removed again more easily from a cell vessel than electrolyte that has penetrated into the pores: The force that is required to drive the electrolyte out again from the pores is significantly greater than the force that is required to remove from the cell vessel the electrolyte that is not located in the pores. The invention makes use of this effect by arranging that, in the first filling step, more electrolyte than is required altogether for occupying the free volume of the cell is introduced (excess amount). Immersed in the excess amount, the component is optimally impregnated with electrolyte, that is to say it takes up electrolyte until the free volume is completely filled with electrolyte.

In order not to leave an unnecessarily great amount of electrolyte in the cell vessel, in the second step the electrolyte introduced is exposed to a force that drives out again from the cell vessel the excess electrolyte, that is to say the part that is not located in the pores of the porous component. This force is set to be great enough to drive out the part of the electrolyte that is located outside the pores, but not great enough to be capable of overcoming the retaining forces of the pores that retain the electrolyte in the pores. By correctly setting the level of the force, this achieves the effect of dividing the total amount of the electrolyte introduced, to be specific into the excess amount of electrolyte located outside the pores and the optimum filling amount, which corresponds to the free volume.

Another important operating parameter apart from the level of the force is of course also the time of exposure in which it acts, since a movement of the electrolyte out of the cell vessel must first be induced by the force acting. Finally, the point in time at which the exposure to the force begins is an important operating parameter. It must therefore be taken into account that the electrolyte requires a certain time to penetrate into the pores. Therefore, the electrolyte is subjected to the force at the given point in time after the impregnation of the porous component has taken place.

Prescribing the necessary force, the necessary time of exposure and the point in time at which the exposure to the force begins is dependent on the flow behaviour of the electrolyte, the size of the cell and the porosity of the components. The optimum values can be determined by a simple experiment.

Another important aspect of the invention is the added amount of electrolyte, which is introduced in the second filling step. This added amount ensures that there is always more electrolyte in the cell vessel than is required with regard to the actual free volume. This is so because it has been found that, after closing the cell vessel, that is to say during the forming of the cell and/or during its operation, electrolyte is still consumed. Consequently, this amount of loss occurring after closing must be included in the calculation. This takes place by using the added amount.

The added amount consequently takes into account an error in driving out the part of the electrolyte that is not located in the pores of the porous component and at the same time the consumption after closing of the cell vessel. Here, too, a corresponding empirical value with regard to the type of cell construction and its operating states should be taken into account.

The force to which the electrolyte introduced is subjected in order to drive out of the cell vessel the part of the electrolyte that is not located in the pores of the porous component may vary in its nature:

In the simplest case, the force is the gravitational force, which accelerates the electrolyte in the direction of the Earth in the same way as all objects that have a mass. In order to make use of this, the cell vessel is tipped over, so that the gravitational force drives the electrolyte out of the cell vessel. The pouring out of the cell vessel is particularly easy, because gravitational force is omnipresent. During the pouring out, the electrolyte that is not located in the pores flows out of the cell vessel first. The part of the electrolyte that is located in the pores requires a greater force to be driven out, which is only slowly exceeded by the gravitational force. In this way, a simple separation of the parts of the electrolyte can be performed. Another advantage of making use of gravitational force is that, according to experience, it is of the correct level to perform a separation of the parts of the electrolyte.

Alternatively, it is possible to set the cell vessel in rotation, so that the centrifugal force thereby produced drives out the part of the electrolyte that is not located in the pores. An advantage of using the centrifugal force is the simple way in which it can be technically realized with a turntable for the cell and the good way in which the force can be set by using the rotational speed.

As a variant, it is conceivable to drive out the excess by means of its force of inertia, in that the cell vessel as a whole is accelerated.

As a further variant for applying the force, the invention proposes exerting on the cell vessel an external compressive force, which results in a force of reaction that drives the electrolyte out of the cell vessel. This method is of interest in particular whenever the cell vessel is a film bag that has a comparatively thin and therefore deformable wall, which makes it easily possible for the electrolyte to be subjected to a compressive force from the outside.

Conversely, it is also possible to generate a negative pressure within the cell vessel, which brings about a sucking force that drives out the electrolyte. This takes place in the simplest case by means of a sucker introduced into the cell vessel, which sucks the surplus electrolyte out of the cell vessel.

Finally, it is also possible not to apply the force mechanically, but on the basis of the thermal expansion of the electrolyte that occurs when the cell vessel is subjected to heat. The expansion force resulting from the thermal expansion is suitable for driving out surplus electrolyte from the cell vessel. When heating up the electrolyte, it must be ensured that it is not vaporized. This variant of the method can only be applied to cell vessels with a comparatively dimensionally stable vessel; known as “hardcase cells”.

It goes without saying that the enumerated measures for driving out the electrolyte can also be combined with one another, so that forces varying in nature act on the electrolyte at the same time or one after the other.

Before the introduction of the electrolyte in the first filling step, the cell vessel does not necessarily have to be empty—apart from the porous component. Since, under some circumstances, electrodes and separators tend towards oxidation and moisture absorption, it may be advantageous to fill the cell vessel beforehand with a non-oxidizing atmosphere of a defined dryness, that is to say an inert gas such as for example nitrogen, argon or hydrogen. However, the cell components are usually not susceptible to oxidation, but rather are sensitive to moisture; this is particularly the case whenever the electrochemical element is a secondary cell with a nonaqueous electrolyte, such as for example lithium-ion rechargeable batteries. Cell components of this cell should be protected from atmospheric moisture, and so they are stored, handled and installed under dry conditions. Consequently, the cell vessel may also be filled with air before the first filling step. In some special cases, it is also conceivable that the cell vessel is filled with forming gas, a gas mixture consisting of approximately 95% by volume nitrogen and 5% by volume hydrogen, which is at the same time inert and has a reducing effect.

If the cell vessel is filled with such a gas or gas mixture before the introduction of the electrolyte in the first filling step, the invention proposes that, after the first filling step, the cell vessel is left with the cell component immersed until the gas or gas mixture located in the pores of the cell component comprising the excess amount of electrolyte has been outgassed. Consequently, before the introduction of the electrolyte, the pores are filled with gas, which first has to be displaced by the electrolyte. This takes a certain amount of time. For this reason, the added amount of electrolyte is only introduced in the second filling step after waiting after the first filling step until the gas has bubbled out of the electrolyte. The time for which it is left is determined empirically. Experiments simply involve measuring the time during which air gas bubbles rise up out of the electrolyte. The time period from when the electrolyte is introduced until the formation of bubble subsides is chosen as the time for which it is left.

In order to shorten the time for which it is left, it is advisable to promote the outgassing. This can be promoted for example by carrying out a change in pressure and/or temperature of the excess amount of electrolyte. This thermodynamic approach increases the mobility of the gas in the electrolyte, and consequently speeds up the escape of the gas from the electrolyte.

In addition or alternatively, it is possible to subject the cell vessel to an external force in order to promote the outgassing. A compressive force exerted on the cell vessel or vibrations come into consideration in particular as the external force.

Apart from a gas filling, it is conceivable that the cell vessel is evacuated before the first filling step, so that it is predominantly devoid of gas. In this case, it is appropriate to use the vacuum located in the cell vessel for sucking the excess amount of electrolyte into the cell vessel in the first filling step. The advantage of this method is that the outgassing operation after introduction of the electrolyte is speeded up.

As stated at the beginning, an electrochemical cell generally comprises a number of porous cell components, such as for example an anode, a cathode and a separator. If the cell vessel contains a plurality of porous cell components, it is preferred if in the first filling step an excess amount of electrolyte is introduced, in which all of the cell components located in the cell vessel are completely immersed. The method is used particularly advantageously in the production of lithium-ion secondary batteries, in which the cell vessel is a film bag (known as “pouch cells”) and the porous cell component is a cathode, an anode or a separator. The electrolyte is preferably a liquid electrolyte, in particular a nonaqueous electrolyte in the form of lithium salts which are dissolved in an organic solvent or in an ionic liquid. Electrolytes in gel form may also be used, or solid electrolytes if they are introduced into the cell vessel in a flowable state in the same way as a polymer electrolyte.

An important feature of the method according to the invention is that the porous cell component immersed in the excess amount of electrolyte is impregnated by electrolyte. The pores are thereby filled with electrolyte. Then, the electrolyte that is not located in the pores is removed from the surroundings of the porous cell component. In the case of the embodiments of the invention described so far, this takes place by driving out of the cell vessel the electrolyte that is not located in the pores.

An equivalent solution for achieving the object on which the invention is based comprises kinematic reversal of the driving out of electrolyte that is not located in the pores. It is not the electrolyte that is removed from the cell vessel, but the cell component that is removed from the electrolyte. For this purpose, the invention proposes not performing the impregnation of the cell component inside the cell vessel but outside it. The excess amount is accordingly not introduced into the cell vessel, but is provided in a basin outside the cell vessel. The sequence of the method is then as follows:
a) in the course of the impregnating step, the porous cell component is completely immersed in an excess amount of electrolyte,
b) then, the porous cell component is removed from the excess amount of electrolyte and is exposed to at least a force that removes from the cell component the part of the electrolyte that is not located in the pores of the porous cell component,
c) if it has not already happened, the porous cell component is then inserted into the cell vessel;
d) finally, in a filling step, an added amount of electrolyte is introduced into the cell vessel.

The subject matter of the invention is consequently also a method for producing an electrochemical cell, in particular a secondary battery or a double-layer capacitor, in which a cell vessel containing at least one porous cell is filled with a flowable electrolyte,
a) in which, in an impregnating step, the porous cell component is completely immersed in an excess amount of electrolyte,
b) in which the porous cell component is removed from the excess amount of electrolyte and exposed to at least a force that removes from the cell component the part of the electrolyte that is not located in the pores of the porous cell component,
c) in which the porous cell component is inserted into the cell vessel then or already before the impregnating step;
d) and in which then, in a filling step, an added amount of electrolyte is introduced into the cell vessel.

The common inventive concept of the two solution proposals is
that the cell component is impregnated with electrolyte by immersion in the excess amount (after the first filling step or in the impregnating step),
that electrolyte that is not located in the pores is eliminated from the surroundings of the cell component (by driving electrolyte out of the cell vessel or by removing the cell component from the electrolyte),
and that, along with the impregnated component provided in the cell vessel, an added amount of electrolyte is introduced into the cell vessel.

In this variant of the method, the elimination of the surplus electrolyte from the surroundings of the impregnated cell component takes place in an analogous way by forces that vary in nature:

In the simplest case, the force is gravitational force: After removing the cell component from the excess amount, the electrolyte that is located in the pores is allowed to drip off from the cell component.

In a second embodiment, the force is the centrifugal force. By rotating the removed cell component, electrolyte that is not located in the pores is spun away.

In a third embodiment, the force is the force of inertia. By subjecting the removed cell component to an acceleration, electrolyte that is not located in the pores is spun away.

Furthermore, it is possible to strip off the electrolyte that is not located in the pores from the cell component with a stripper. The force is then a force of reaction on the stripper.

Finally, a sucking force may be used in order to remove electrolyte that is not located in the pores from the cell component. For this purpose, the cell component removed is sucked up with a sucker.

It goes without saying that these approaches to eliminating surplus electrolyte from the cell component may also be combined with one another and/or one after the other.

In a particularly preferred embodiment of the second variant, the cell component is immersed into a basin containing the excess amount of electrolyte. This can be realized most easily. It is preferably not immersed into the basin in a vertical direction but at an angle. This is conducive to the impregnation, since the gas located in the pores can escape better.

It is even possible to immerse the cell component together with the cell vessel into the basin containing the excess amount of electrolyte, the cell vessel being open when it is immersed into the excess amount of electrolyte and only finally closed after introduction of the added amount. Accordingly, the insertion of the cell component into the cell vessel takes place before the impregnation.

In the end, the immersion of the cell vessel into the basin also represents introduction of the excess amount into the cell vessel, which shows that the two approaches to a solution implement the same inventive concept.

In the case of all the methods, the individual filling steps do not have to introduce the envisaged filling amount into the cell vessel in one go. It is also conceivable that at least one of the filling steps is divided into a number of substeps, the excess amount or the added amount being introduced in a quantified manner in a number of substeps.

Both methods are suitable in particular for filling lithium-ion secondary batteries, the cell vessel of which is a film bag. The porous cell component is then either a cathode, an anode or a separator or a combination of these components, that is to say what is known as a cell stack or cell winding.

The present invention will now be explained in more detail on the basis of exemplary embodiments. The figures show, in schematic form:

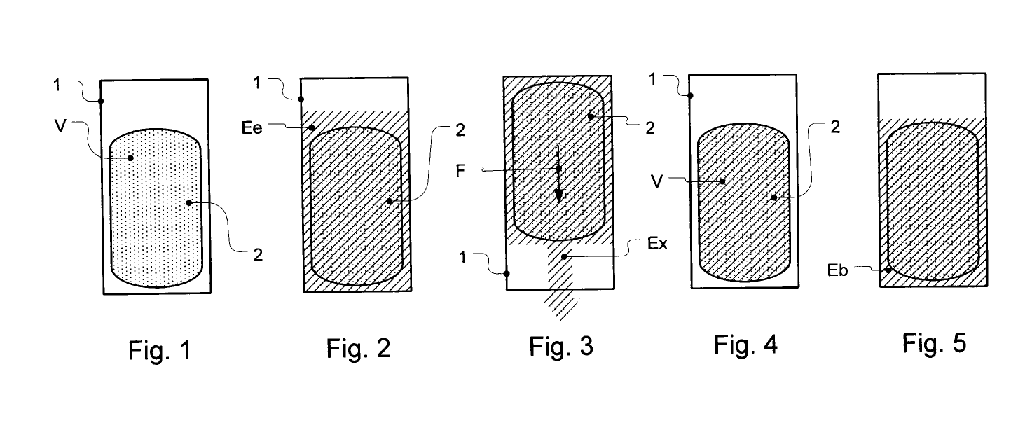

FIG. 1 an empty cell vessel with a porous component;

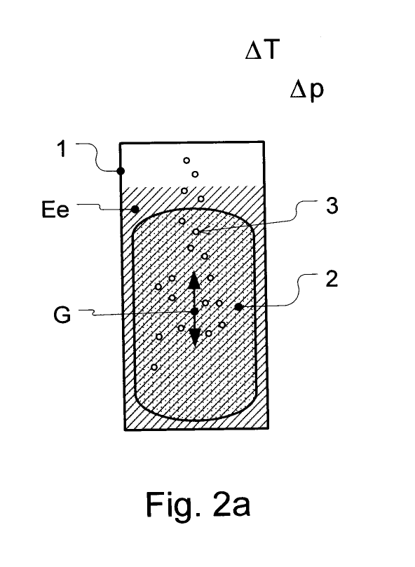

FIG. 2 a cell vessel after the first filling step;

FIG. 2a optional promotion of the driving out of gas;

FIG. 3 subjecting the electrolyte to a force;

FIG. 4 impregnated component in the cell vessel;

FIG. 5 a cell vessel after the second filling step;

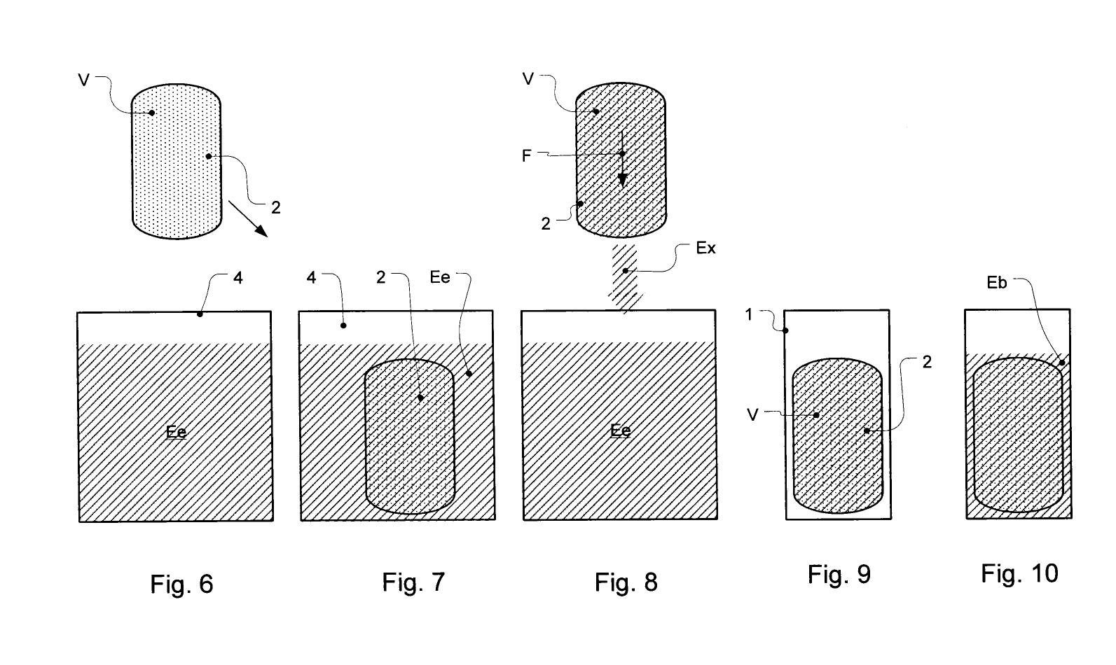

FIG. 6 a basin filled with excess amount of electrolyte;

FIG. 7 immersion of a porous component into the basin;

FIG. 8 dripping off of the impregnated component;

FIG. 9 an impregnated component in the cell vessel;

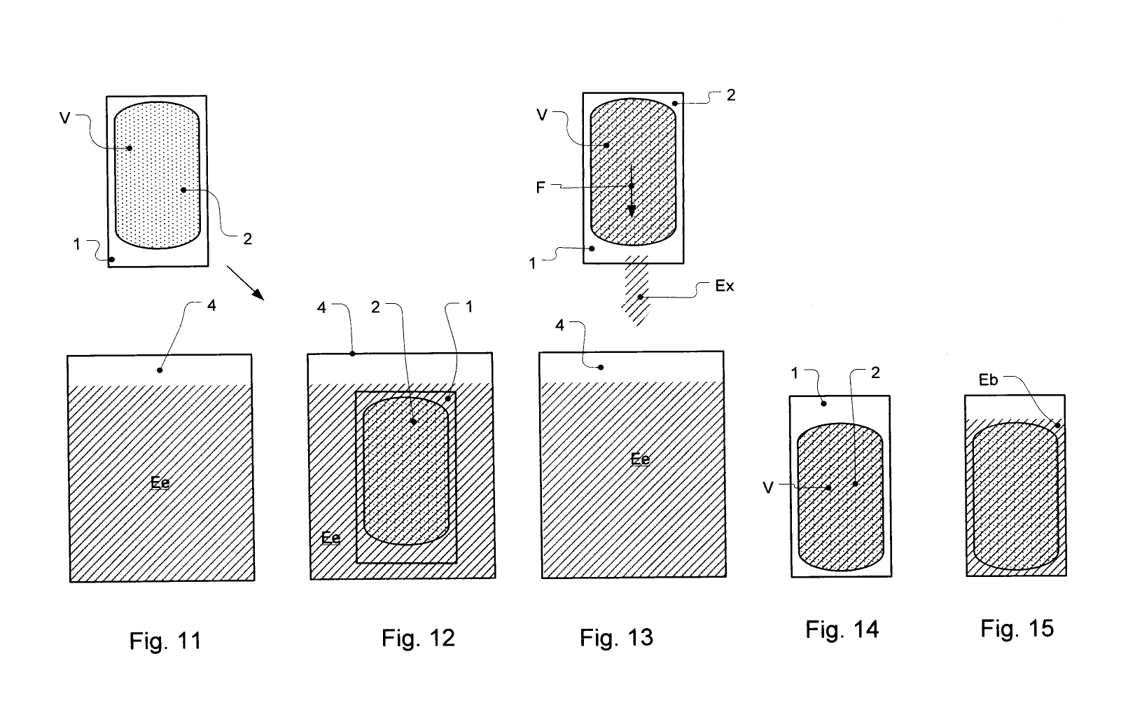

FIG. 10 a cell vessel after introduction of the added amount;

FIG. 11 a basin filled with excess amount of electrolyte;

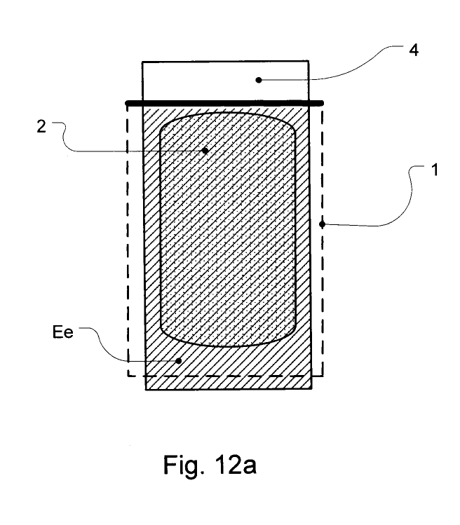

FIG. 12 immersion of a porous component in the cell vessel into the basin;

FIG. 12a a variant basin size;

FIG. 13 dripping off of the impregnated component in the cell vessel;

FIG. 14 an impregnated component in the cell vessel;

FIG. 15 a cell vessel after introduction of the added amount.

FIGS. 1 to 5 represent the basic sequence of a first method according to the invention; FIG. 2a shows an optional additional step, which is to be provided between FIGS. 2 and 3.

FIGS. 6 to 10 represent the basic sequence of a second method according to the invention.

FIGS. 11 to 15 represent a variant of the second method according to the invention in which the cell vessel is immersed together with the cell component into the basin.

In a cell vessel 1 there is a porous cell component 2. Since the cell component 2 is not solid, but porous, the difference between the empty volume of the cell vessel 1 and the solid volume of the cell component 2 represents the free volume V of the electrochemical cell. The free volume V consequently corresponds to the void spaces within the porous component 2.

The aim is to fill the free volume V as exactly as possible with electrolyte, that is to say to impregnate the porous component optimally.

For this purpose, in a first filling step, an excess amount of electrolyte Ee is introduced into the cell vessel 1, until the cell component 2 is immersed completely (cf. FIG. 2).

The first filling step may also be divided into a plurality of substeps, so that the excess amount of electrolyte Ee is introduced in a quantified manner.

Then, in a second working step (FIG. 3), the electrolyte Ee introduced is exposed to a force F that drives out of the cell vessel 1 the part Ex of the electrolyte that is not located in the pores of the porous component 2. This takes place simply by tipping over the cell vessel and pouring out the surplus.

After driving out the part Ex of the electrolyte that is not located in the pores of the component 2, this achieves the effect that the cell vessel 1 is filled ideally with an amount of electrolyte that corresponds to the free volume V (cf. FIG. 4).

In a second filling step, an added amount Eb of electrolyte is then introduced, so that the filling level of electrolyte E is greater than the free volume V (FIG. 5). Then the cell is closed (not represented).

The purpose of the added amount Eb fed in is that electrolyte within the cell vessel is broken down during the forming of the cell or during the operationally related ageing. The added amount Eb compensates for this.

FIG. 2a shows an optional working step, in which, after the introduction of the excess amount of electrolyte Ee in the first filling step, the cell vessel 1 is left until gas 3 located in the pores of the cell component 2 has outgassed from the electrolyte Ee. This working step is optionally arranged between FIGS. 2 and 3. In order to shorten the time for which it is left, it is appropriate to subject the electrolyte Ee to a force G promoting the outgassing of the gas during the time for which it is left. This may preferably be a force of inertia G resulting from a vibration of the cell vessel. In addition, a change in pressure Δp or a change in temperature Δt may be performed in order to shorten the time for which it is left during the outgassing. The outgassed pores are filled by electrolyte.

FIGS. 6 to 10 show a second variant of the method, in which the excess amount Ee is located outside the cell vessel, to be specific in a basin 4 of which the volume is much greater than that of the cell vessel (FIG. 6).

The cell component 2 is immersed into the basin 4, so that the free volume V is completely impregnated with electrolyte (FIG. 7). The cell component 2 preferably enters the basin 4 at an angle, in order that the pores fill better with electrolyte.

Then, the cell component 2 is removed again from the excess amount of electrolyte Ee (FIG. 8). The gravitation exerts on the electrolyte a force F that allows the part of the electrolyte Ex that is not located in the pores to drip off. This is caught by the basin 4. An optimally impregnated cell component 2 remains, since the gravitation is not enough also to remove the electrolyte that is retained in the pores.

Then, the completely impregnated cell component 2 is inserted into the cell vessel 1 (FIG. 9).

Finally, the added amount of electrolyte Eb is introduced into the cell vessel 1 (FIG. 10).

It is also conceivable to immerse the cell vessel 1 together with the cell component 2 into the basin 4, as FIGS. 11 to 15 show:

The cell component 2 is inserted into the cell vessel 1 empty of electrolyte. The cell vessel 1 is not yet closed, or at least is only partially closed. In the case of pouch cells, in particular, only a sealing seam is welded, the rest remains open (FIG. 11).

The cell vessel 1 with the inserted cell component 2 are together immersed into the basin 4 with the excess amount of electrolyte Ee and are left there until impregnation is completed (FIG. 12).

The cell vessel 1 and the cell component 2 are together removed from the basin 4. Electrolyte Ex that is not located in the pores drips off (FIG. 13).

The cell vessel 1 filled with the completely impregnated cell component 2 remains (FIG. 14).

Finally, the added amount of electrolyte Eb is introduced into the cell vessel 1 (FIG. 15), and the cell vessel 1 is then completely closed (not represented).

In FIGS. 11, 12, 13, the basin 4 is made much larger than the cell vessel 1. This means that the excess amount Ee is very much greater than the free volume V. When the cell vessel (FIG. 12) is immersed, the outside of the cell vessel is accordingly also covered with electrolyte, which must drip off again (FIG. 13). This can be avoided with pouch cells, in that the individual film parts of the bag are only adhesively attached to the top of the cell; the other portions remain unsealed. It is then possible to fold back the unsealed parts of the film bag to the sides—in a way similar to a half-peeled banana—in order at least partially to avoid the folded-back parts of the film coming into contact with electrolyte during the immersion of the porous component 2. The basin 4 should then be made to correspondingly smaller dimensions, in order that the unsealed film parts enclose the basin 4 on the outside. This alternative is schematically represented in FIG. 12a. There, the top of the film bag 1 is shown by a solid line, the unsealed edges of the bag are shown by dashed lines.

This results in a particularly simple concept, which makes it possible to fill the free volume of an electrochemical cell optimally with electrolyte, so that the cell achieves a high level of performance. An advantage is the strikingly simple construction, which manages without complicated control engineering and is therefore particularly operationally reliable. Since, by making use of the retaining forces applied by the pores, the excess amount is separated from the optimum amount in a simple way, the filling method works in a virtually self-limiting manner. Another important aspect of the invention is the added amount, which compensates for the later operationally related breakdown of electrolyte, and consequently ensures a high level of performance and operational reliability over the entire lifetime of the cell. Two approaches to the method for implementing the concept have been presented: In the case of the first variant, the excess amount is located in the cell vessel and must accordingly be removed again after impregnation is completed. In the case of the second variant, the impregnation takes place within a basin containing the excess amount. The second variant can also be carried out in such a way that the cell vessel is immersed together with the cell component into the basin.

### LIST OF DESIGNATIONS

1 Cell vessel

2 Cell component

3 Gas

4 Basin

Ee Excess amount of electrolyte

Eb Added amount of electrolyte

Ex Part of the electrolyte that is not located in the pores

F Force for driving out the part of the electrolyte that is not located in the pores

G Force for promoting outgassing

V Free volume

Δp Change in pressure

Δt Change in temperature

1. A method for producing an electrochemical cell comprising:
first filling a cell vessel that contains at least one porous cell component with an excess amount of a flowable electrolyte that immerses the at least one porous cell component;
exposing the cell vessel containing the flowable electrolyte to at least one force that drives out of the cell vessel a part of the electrolyte that is not located in the pores of the porous component; and then
second filling the cell vessel with an additional amount of flowable electrolyte.

2. The method according to claim 1, wherein said at least one force comprises a gravitational force that drives out the flowable electrolyte when the cell vessel is tipped over.

3. The method according to claim 1, wherein said at least one force comprises a centrifugal force that drives out the flowable electrolyte when the cell vessel is rotated.

4. The method according to claim 1, wherein said at least one force comprises an inertial force that drives out the flowable electrolyte when the cell vessel is accelerated.

5. The method according to claim 1, wherein said at least one force comprises a reactive force that drives out the flowable electrolyte when the cell vessel is externally compressed.

6. The method according to claim 1, wherein said at least one force comprises a compressive force that drives out the flowable electrolyte when the pressure in the interior of the cell vessel is lower than the pressure outside of the cell vessel (“internal negative pressure”).

7. The method according to claim 1, wherein said at least one force comprises an expansive force that drives out the flowable electrolyte when the cell vessel or the electrolyte inside the cell vessel is heated.

8. The method according to claim 1, further comprising before said first filling with a flowable electrolyte, filling the pores of the at least one porous cell component with argon, air, hydrogen, nitrogen, forming gas, or some other gas or gas mixture:
immersing the at least one porous cell component with the flowable electrolyte during said first filling, and
leaving the at least one porous cell component immersed until said gas or gasses have gassed out of the pores.

9. The method according to claim 8, wherein the gassing out is promoted by changing the pressure and/or temperature of the flowable electrolyte in the cell.

10. The method according to claim 8, wherein the outgassing is promoted by subjecting the cell vessel to an external force.

11. The method according to claim 1, wherein the cell vessel is evacuated before the first filling creating a vacuum inside the cell and the flowable electrolyte enters the cell by filling the vacuum.

12. A method for producing an electrochemical cell, comprising:
impregnating at least one porous cell component with a flowable electrolyte, wherein said at least one porous cell component is immersed into an excess amount of electrolyte; and then
removing the at least one porous cell component from the excess amount of electrolyte and exposing it to at least one force that removes the part of the electrolyte that is not located in the pores of the porous cell component;
incorporating the at least one porous cell component into a cell vessel either before or after said impregnating or said removing; and then
introducing an additional amount of flowable electrolyte into the cell vessel.

13. The method according to claim 12, wherein said at least one force comprises a gravitational force that removes excess electrolyte not located in the pores of the porous cell component after the porous cell component has been removed from the excess amount of flowable electrolyte.

14. The method according to claim 12, wherein said at least one force comprises a centrifugal force that removes excess electrolyte not located in the pores of the porous cell component after the porous cell component has been removed from the excess amount of flowable electrolyte.

15. The method according to claim 12, wherein said at least one rotational force that removes excess electrolyte not located in the pores of the porous cell component after the porous cell component has been removed from the excess amount of flowable electrolyte.

16. The method according to claim 12, wherein said at least one force comprises a stripping force resulting from action of a stripper on the porous cellular component that removes excess flowable electrolyte that is not located in the pores of the porous cellular component.

17. The method according to claim 12, wherein said at least one force is caused by application of a vacuum to the porous cellular component that removes excess flowable electrolyte that is not located in the pores of the porous cellular component.

18. The method according to claim 12, wherein the porous cell component is immersed into a basin containing the excess amount of electrolyte.

19. The method according to claim 12, wherein the porous cell component is immersed together with the cell vessel into a basin containing the excess amount of electrolyte, the cell vessel being open when it is immersed into the excess amount of electrolyte and only finally closed after introduction of the added amount.

20. The method according to claim 1, wherein the first and/or second filling is divided into a number of substeps which incrementally introduce the excess amount or the additional amount of flowable electrolyte.

21. The method according to claim 1, wherein said vessel is a film bag and the porous cell component is selected from the group consisting of a cathode, an anode, and a separator, or combinations thereof; and wherein said method produces a cell suitable for a lithium ion secondary battery.

22. A porous electrolytic cell component made by the method according to claim 1.

23. An electrochemical cell comprising the porous electrolytic cell component of claim 22.
